(19) United States
(12) Patent Application Publication
(10) Pub. No.: US 2014/0053734 A1
(43) Pub. Date: Feb. 27, 2014

(54) DEVICE FOR PRODUCING HOT BEVERAGES

(71) Applicant: Roberto Santi, Busto Garolfo (IT)

(72) Inventor: Roberto Santi, Busto Garolfo (IT)

(21) Appl. No.: 14/114,230

(22) PCT Filed: Apr. 26, 2012
(86) PCT No.: PCT/EP12/57658

§ 371 Date: Oct. 28, 2013

(30) Foreign Application Priority Data
Apr. 29, 2011 (IT) MI2011A000725

(51) Int. Cl. A47J 31/44

(52) U.S. Cl. CPC A47J 31/4403
USPC 99/282

(57) ABSTRACT

The present invention relates to a device (1; 2; 3; 4; 5; 6; 7;8) for producing hot beverages comprising: -heating means (40) for producing hot water; -first sensor means (50; 60) for measuring first temperature data of said hot water; -pumping means (200) of said hot water, operatively connected to said heating means (40), for producing pressurized hot water; -second sensor means (30) for measuring first pressure data of said pressurized hot water; -dispensing means (100) of said beverages,operatively connected to said heating means (40) and to said pumping means (200); said device (1; 2; 3; 4; 5; 6; 7; 8) also comprising control means (80), operatively connected to said first sensor means (50; 60) and to said second sensor means (30), for continuous monitoring of said first temperature data and of said first pressure data during the operating phase of said device (1; 2; 3; 4; 5; 6; 7; 8); said control means (80) being operatively connected to said heating means (40) and to said pumping means (200) for continuous and combined control of said temperature and of said pressure during said operating phase of said device (1; 2; 3; 4; 5; 6; 7; 8).

The present invention relates to a device for producing hot beverages. In particular, the present invention relates to a device for continuous and combined control of the temperature variable and of the pressure variable of the water required during production of hot beverages. The term hot beverages, in the present invention, refers to various types of beverages obtained by extracting components by immersing in water, or by solubilizing, solid substances containing the components to be extracted. These beverages include, in particular, coffee and tea, as is commonly known. In the remaining part of the text reference will be made to the production of the beverage coffee by way of example of production, according to any type of production of this latter and any type of initial raw material (roasted coffee for espresso, roasted coffee for Americano, decaffeinated roasted coffee, and the like). However, this must not be considered as a limitation of the device claimed, this latter being capable of producing any hot beverage according to the aforesaid definition.

The production of a high quality coffee beverage depends on a plurality of factors linked to the type and quality of the raw material, to the operating method of the device destined to produce the beverage and to the interaction of the aforesaid factors. Two important elements relating to the type and quality of the raw material are constituted by the roasted coffee blend and the grinding process.

The blend can consist of green coffee of different origins having different organoleptic properties. This is roasted, separately or together, in different degrees. In fact, only very few green coffees have origin flavors having, per se, an organoleptic profile capable of providing a set of well-balanced sensory properties to the coffee ready for consumption, but also in these cases skilful roasting, among the other variables, is decisive. In fact, to obtain a valid blend the flavor, aroma and body of various coffees must be blended. Blending means selecting green coffees of different quality and origin, creating a blend of the various types capable of giving the typical characteristics of the beverage to be obtained. This is the starting point for obtaining, after all the other interconnected process variables have acted, the result in the cup, which will be a mix of the over eight hundred molecules of different type present in the coffee ready for consumption. A good coffee can be called such if the cup has a sensory note, i.e. a well-balanced combination of molecules suitable to satisfy the sensory perceptions involved: visual (color, appearance of the cream), olfactory (aroma), gustatory (acid, bitter), tactile (body, astringency).

The grinding process determines grind size, i.e. the dimensions of the particles constituting the coffee powder to be used and is obtained by grinding roasted coffee beans. Grinding is fundamental to obtain an optimal beverage. If the coffee is too coarsely ground it is less soluble, and therefore the water runs through without extracting all the aroma and flavor. On the contrary, if the coffee is too finely ground, it produces a brew that is too strong, at times with a burnt, bitter flavor.

Further factors related to the raw material comprise the dose of ground powder to use to produce a coffee beverage and the pressing of this powder in the specific retaining filter.

Devices for producing coffee are commonly called coffee machines. Usually, they comprise a boiler connected to a container, or to the mains water supply, for the water to be used during production of the coffee. Moreover, they comprise a pump capable of conveying the water heated by the boiler to the brewing chamber and, then, the extract to the dispensing point.

Therefore, coffee machines are capable of heavily influencing further decisive factors for obtaining a high quality beverage. These factors comprise brewing temperature, brewing pressure and brewing time of the coffee powders. Furthermore, some devices are also capable of controlling variables relating to the raw material, previously described, such as doses and pressing of the ground product.

Numerous types of coffee machines are known. Usually, these use a similar operating principle consisting of heating the water to a certain temperature, pressurizing it to a certain pressure and leaving it brewing with the ground coffee powder for a pre-established time, in such a manner as to allow extraction of all the components from the blend being brewed. These machines differ mainly in relation to the methods with which this powder is inserted into the brewing chamber. In particular, there are known machines that grind the beans directly, machines that use powder stored in specific containers, from which the correct dose quantity is collected, machines that use pods or machines that use capsules.

A further differentiation between known devices relates to the elements of which they are constituted and the methods with which these interact to perform the method to extract the coffee beverage.

EP 1 523 263 describes a machine for producing hot water, steam and hot beverages comprising a boiler of the saturated steam storage type. In particular, a control unit connected to the boiler prevents thermal collapse of the boiler as a consequence of supplying hot water for other services, such a water for tea or steam, and of the related integration of cold water. The hot water used to prepare the coffee can be heated according to two methods. In a first method, a heat exchanger passes through said pressurized boiler and heats the water passing through the heat exchanger by thermal conduction. Subsequently, this water can be mixed if necessary with cold water. A second method provides for the use of a further boiler adapted to heat the hot water for the coffee by means of a separate circuit.

This solution guarantees a constant pressure level in the boiler, to meet large and repeated work loads. However, it has the disadvantage of not performing any temperature regulation, except for the one preset on the same boiler. Moreover, a further disadvantage lies in the fact that it is impossible to maintain the temperature value constant but, using a thermostat, this maintains the values within a control interval in relation to the sensitivity of this same thermostat. Even if the boiler is provided with a temperature sensor, this is fixed so that it does not vary during the brewing process.

EP 1 793 717 describes a coffee machine and a control method of the same machine. In particular, the machine comprises a continuous heating device which heats the water collected, by means of a pump, from a container. This is subsequently sent, again by pumping, to a brewing chamber inside which there is inserted a temperature sensor. This sensor is connected to a control device capable of interrupting the flow of the pump and/or the heating of the heating device when the temperature exceeds a given threshold value.

This solution therefore allows a given temperature value to be reached in the brewing chamber in a precise manner. However, this value cannot be varied according to the beverage selected. Even more disadvantageous is the lack of connection between the pump and the heating device, thus making it impossible to control them simultaneously. Therefore, this prevents control and/or variation of said parameters during production and dispensing of the beverage.

EP 1 938 720 describes a coffee machine comprising a device for heating water, such as a boiler, connected to a container by means of a transportation duct. The heating device is also connected to a brewing chamber again by means of said transportation duct. This machine also has a temperature sensor, connected to a control device, capable of detecting the temperature of the water supplied to the brewing chamber. By means of the control device, the temperature of the water is therefore regulated so that, to perform pre-brewing, this has a preset value comprised between 50 and 75° C. and a value greater than 85° C., to perform brewing.

This solution is capable of setting the temperature according to a predetermined interval. However, it has the evident disadvantage of not correlating the temperature control to the pressure control. Moreover, the choice of temperature only allows a variability limited to a single value during operating phase, consisting in pre-brewing, brewing and dispensing.

Therefore, it is not possible to obtain controlled variations of temperature and pressure during a single extraction cycle and, in particular, it is not possible to carry out controlled variations of this quantity in relation to the one-to-one influence of temperature and pressure on the extraction of a good coffee beverage.

Therefore, although using solutions comprising systems for controlling the temperature, known devices are unable to guarantee, at the same time, easy operation and stability of use. Moreover, known devices do not allow combined and/or simultaneous control of the water temperature and of the pressure used for extraction of the coffee. Even more disadvantageous is the fact that it is not possible for these devices to modify the parameters described during the operating cycle. In fact, regulation of the temperature and/or pressure can only be carried out before the operating phase so as to reach and maintain these values constant during the whole of the extraction and/or dispensing process.

It would therefore be desirable to obtain a device for producing beverages containing coffee capable of ensuring simultaneous and concurrent regulation of the temperature and pressure variables.

It would also be desirable for said device to be capable of performing said regulation as a function of the type of beverage to be produced, of the type of raw material used and in relation to the input values of the various parameters to be regulated.

Furthermore, it would be desirable for said device to be capable of performing the regulation of the temperature and pressure parameters in a continuous manner during the whole of the beverage extraction and/or dispensing cycle.

It would also be desirable for this device to allow rapid dispensing of the beverages and rapid modification of the settings for subsequent dispensing of different beverages.

Finally, it would be desirable for it to be possible to produce this device economically, minimizing the costs relating to the number of components, their assembly and their interaction.

Within the scope of the aforesaid aim, an object of the present invention is to provide a device capable of ensuring simultaneous and combined control and management of the temperature and pressure variables of the water to be used to prepare the beverage.

A further object of the present invention is to provide a device capable of performing this control and this management of the variables during the whole of the production cycle of the beverages.

Yet another object, falling within the aforesaid aim, is to provide a device capable of managing said variables in relation to the different beverages to be produced, to the type of raw material used and in relation to the input values of the parameters to be regulated. Moreover, a further object of the present invention is to provide a device that allows the rapid production, also in succession, of different beverages, making changes of the set-up and rapid modification of the settings.

The aforesaid objects are accomplished by a movable device for producing hot beverages, characterized in that it comprises:
a. heating means for producing hot water;
b. first sensor means for measuring first temperature data of said hot water;
c. pumping means of said hot water, operatively connected to said heating means, for producing pressurized hot water;
d. second sensor means for measuring first pressure data of said pressurized hot water;
e. dispensing means of said beverages, comprise at least one brewing chamber (16) with variable geometry, operatively connected to said heating means and to said pumping means;
   said device also comprising control means, operatively connected to said first sensor means and to said second sensor means, for continuous monitoring of said first temperature data and of said first pressure data during the operating phase of said device; said control means being operatively connected to said heating means and to said pumping means for continuous and combined control of said temperature and of said pressure during said operating phase of said device; said control means being operatively connected to said brewing chamber for continuous, combined and independent control of said temperature and of said pressure on the basis of the geometry of said brewing chamber; said geometry being determined on the basis of the extraction profile of said beverages.

The term “extraction profile” is intended, in the present invention, as all the information necessary for correct implementation of the production activities for beverages, like the temperature, the pressure and the mixing time. Furthermore, the extraction profile can be related to the grammage of the particles, the pressing force to be applied (or not) at the particles, or even the grain size of the particles (if the device can produce itself the particles from the entire part of product).

With the characteristics described above, the device according to the invention continuously monitors the temperature and pressure variables of the heated water and, therefore, performs combined and continuous control of the means for heating and pressurizing the water. Said monitoring and said control are performed during the whole of the production cycle, or operating phase, of the coffee beverage, in a continuous, combined but independent way.

This allows the use of different quantities of coffee powder for preparing different beverages. Moreover, by means of the variation in geometry, it is possible to use containing means of the coffee, external to the device, such as capsules and the like, of different forms. It is also possible to produce, when necessary, pressing of the coffee powder contained in the containing means.

Furthermore, determining the geometry of the brewing chamber on the basis of the extraction profile of the beverages themselves, it is possible to set the temperature and the pressure, or even the grammage and the pressure force to be applied at the particles, to control on the basis of the same extraction profile. So, temperature, pressure and geometry are variables to combined in independent way to obtain different beverages as request. In particular, one or more extraction profiles can correspond to the same geometry of the brewing chamber and one or more of these, otherwise, can correspond to the same extraction profile. In practice, temperature and pressure can be combined on the basis of the requested extraction profiles of the beverages, without regard to the geometry of the chamber that is a further variable.

The term operating phase, or production cycle, is intended in the present invention as the series of operations necessary to produce the beverages. These comprise, among others, supply and heating of the water, pressurization of the water collected and/of the water heated. They also comprise the pre-brewing, where required, brewing and dispensing phases of the beverages.

Preferably, the device comprises beverage selection means, operatively connected to the control means. These send at least second temperature data and/or second pressure data for the beverages to the control means. The control means perform continuous and combined control of the temperature and of the pressure during the operating phase on the basis of comparison between the first temperature data and the second temperature data and/or between the first pressure data and the second pressure data. Even more preferably, these selection means can be controlled by a user. In this way, the device is capable of producing different beverages in relation to the input data deriving from the beverages selected. Therefore, the control means are capable of adapting the pressure and temperature parameters according to those required for the beverage selected.

Preferably, the first temperature sensor means comprise at least one temperature sensor at the dispensing means. These can be positioned at the input of the brewing portion to ensure precise control of the temperature to be used in contact with the coffee. The temperature sensor can also, or concurrently, be positioned at the heating means. In particular, it can be positioned in contact with the heating means and/or at the hot water dispensing point thereof. This ensures continuous, rapid and precise monitoring of the temperature to be used to brew the coffee during preparation of the beverages.

Even more preferably, the device comprises third sensor means to perform measurement of third temperature data of the input water to the heating means. In this way, it is possible to continuously control the temperature of the input water and, therefore, economize the production of hot water when the input temperature is already high. Moreover, this sensor allows direct use of the input water in the brewing portion if the temperature is sufficient. Further, it is possible to perform mixing with water heated by the heating means.

The third sensor mean, described above, is also important to continuously control the temperature of the input water when it is subject to temperature changes. This occur, for example, due to the changes in seasons, for the water pumped from the public system dispensing, or due to water contained in external container, subject to weather events.

Preferably, the brewing chamber has a variable volume. This is operatively connected to the control means, which perform continuous, combined and independent temperature and pressure control on the basis of the geometry of the brewing chamber said volume being determined on the basis of the extraction profile of said beverages.. This allows the use of different quantities of coffee powder for preparing different beverages. Moreover, by means of the variation in in volume, it is possible to use containing means of the coffee, external to the device, such as capsules and the like, of different forms. It is also possible to produce, when necessary, pressing of the coffee powder contained in the containing means. In this way a further variable, the volume, has to be combined with the temperature and the pressure, in independent way, on the basis of the extraction profile of the beverages. In particular, one or more extraction profiles can correspond to the same volume of the brewing chamber and one or more of these, otherwise, can correspond to the same extraction profile.

Preferably, the device comprises timer means for monitoring the heating time interval and the pressurization time interval. The control means are operatively connected to the timer means to control the heating time interval and/or the pressurization time interval. More preferably, the timer means monitor the dispensing time interval. The control means are operatively connected to the timer means to control the dispensing time interval.

This ensures precise control of brewing and correct management of the temperature and pressure variables, which have a greater influence on the final quality of the beverage. Preferably, the device comprises mixing means for mixing the hot water produced by the heating means with the input cold water to these latter. Even more preferably, the mixing means comprise at least one temperature sensor, operatively connected to the control means. Therefore, in this way it is possible to use the cold water to produce beverages that require brewing water with temperatures below the temperature range that can be produced with the heating means.

Further characteristics and advantages of the present invention will be more apparent from the description of preferred embodiments, illustrated by way of non-limiting example in the accompanying figures, wherein like numbers correspond to the same parts of different devices and wherein:

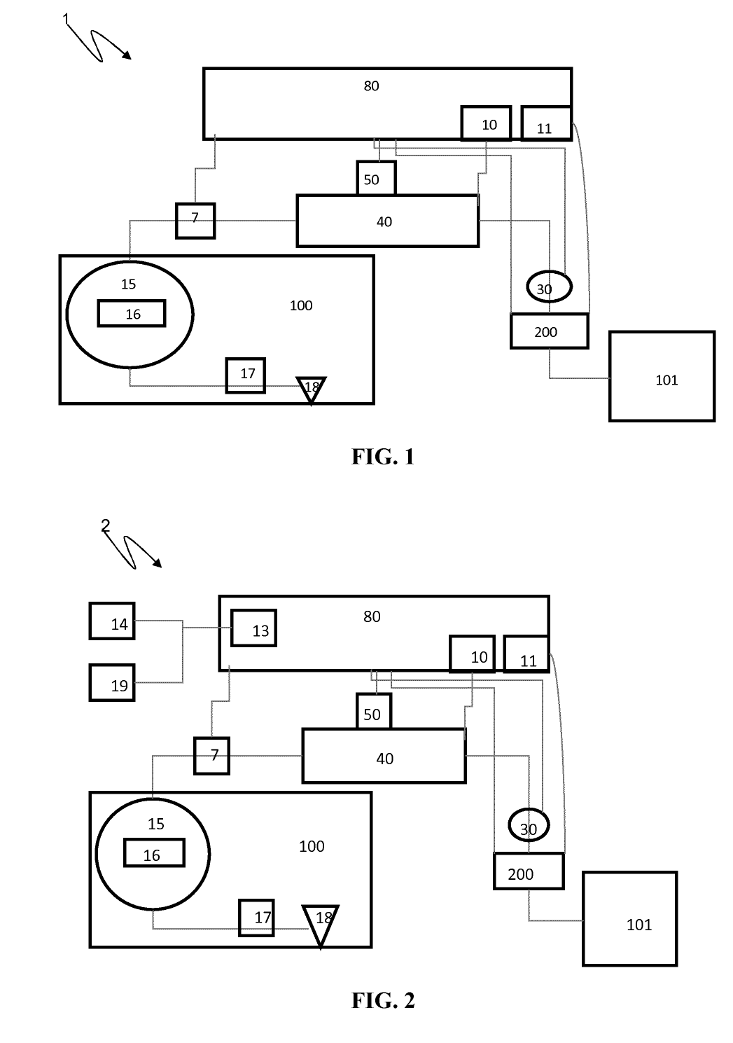

FIG. 1 is a schematic view of a first embodiment of the device according to the present invention;

FIG. 2 is a schematic view of a second embodiment of the device according to the present invention, capable of ensuring selection of the beverages;

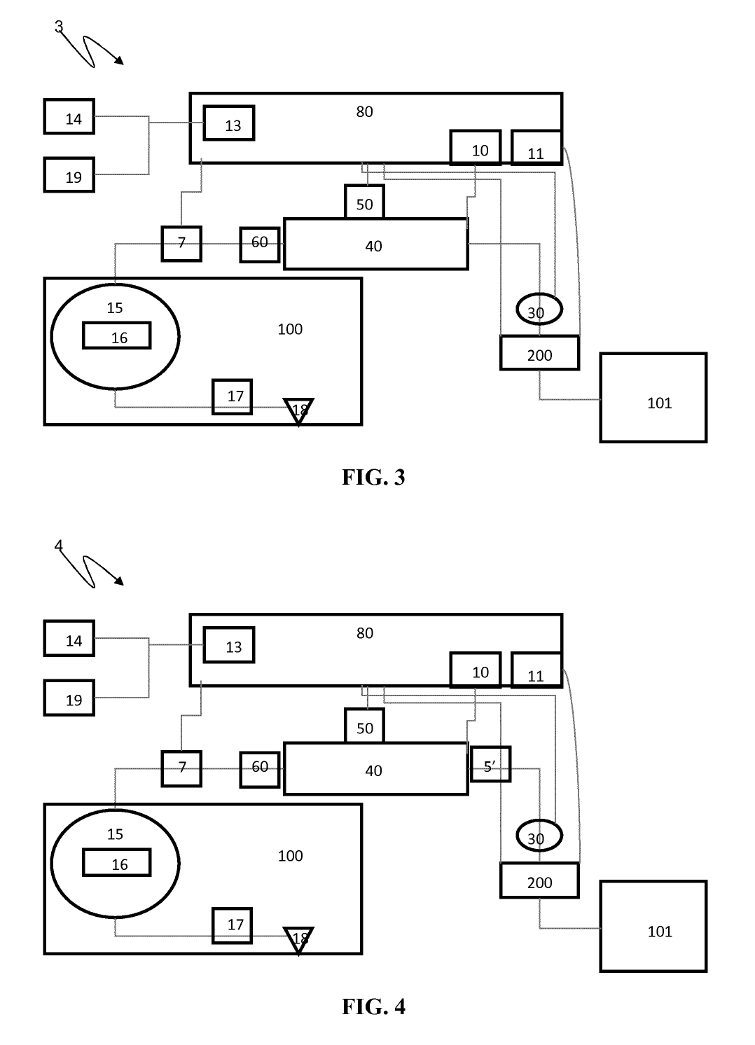

FIG. 3 is a schematic view of a third embodiment of the device according to the present invention, provided with multiple sensor means;

FIG. 4 is a schematic view of a fourth embodiment of the device according to the present invention, provided with sensor means for the input water;

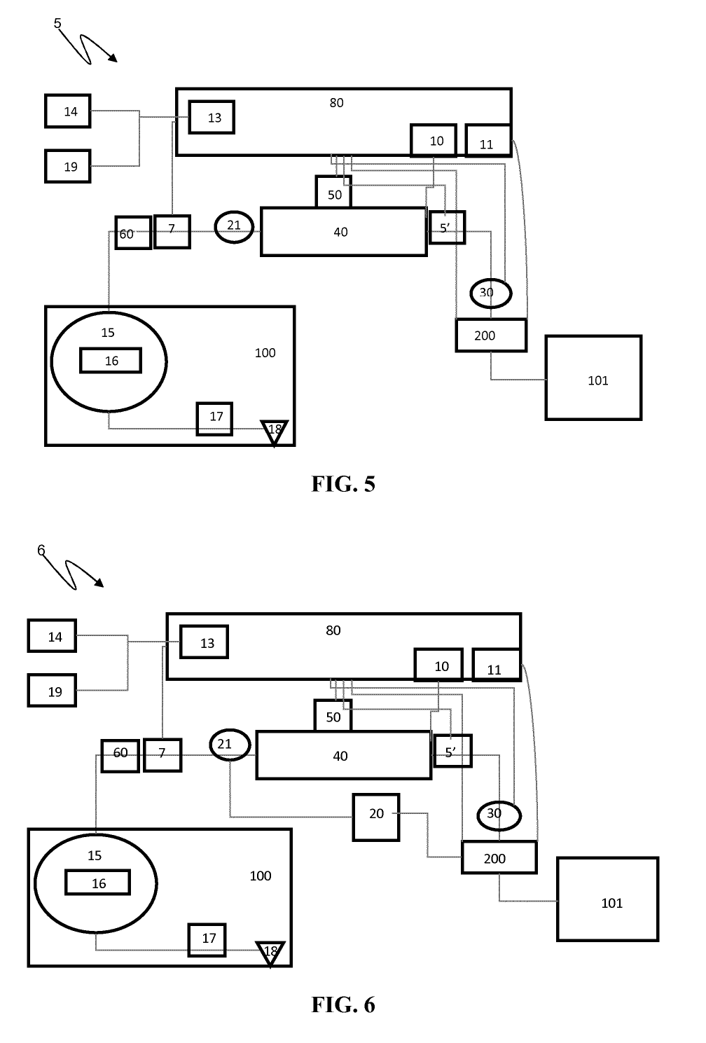

FIG. 5 is a schematic view of a fifth embodiment of the device according to the present invention, comprising further mixing and timer means;

FIG. 6 is a schematic view of a sixth embodiment of the device according to the present invention, provided with proportional valve for supply to the mixer;

FIG. 7 is a schematic view of a seventh embodiment of the device according to the present invention, provided with proportional valve for the general supply of the input water;

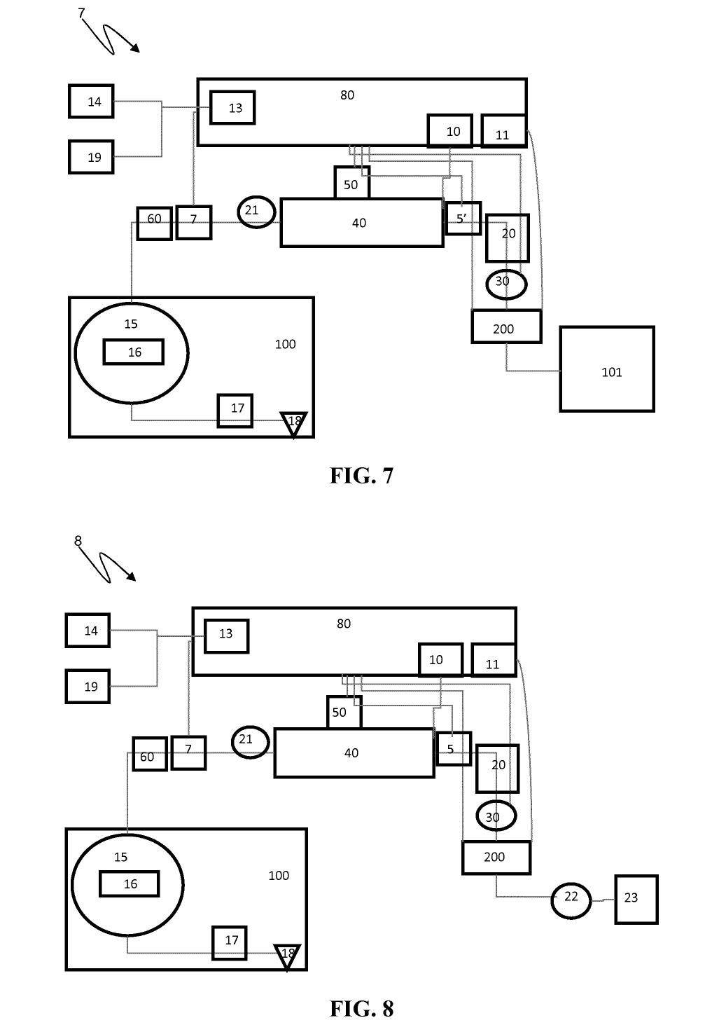

FIG. 8 is a schematic view of an eighth embodiment of the device according to the present invention, with connection to the mains water supply.

Hereunder reference will be made to the use of the device according to the present invention when this is switched on and in thermal steady state, i.e. ready for the dispensing service and therefore the description will relate only to the operating phase.

The operating phase can be divided, briefly, into three subphases. These can be successive or alternative, in relation to the type of beverage to be prepared. A first pre-brewing subphase, a second extraction subphase and a third dispensing subphase.

The term “pre-brewing” is intended, in the present invention, as the phase in which the water, at the given temperature and pressure, soaks the coffee powder carrying out pre-cooking.

The term “extraction” is intended, in the present invention, as the phase in which the substances are extracted from the coffee and the beverage is concurrently dispensed.

The term “dispensing” is intended, in the present invention, as the phase in which the beverage is still being dispensed but, concurrently, also extracted. In particular, usually extraction is with reduced efficiency. The passage of water through the coffee powder, even if at lower pressure and temperature, nonetheless performs an extraction. The decrease in pressure and temperature values is necessary to prevent undesirable substances (such as an excess of tannic substances) from being extracted.

The pre-brewing subphase comprises sending water at a temperature Tₚᵢ and a pressure Pₚᵢ to the capsule, or to the containing means of the coffee powder. These values of Tₚᵢ and Pₚᵢ are variable as a function of the type of beverage to be produced. In this subphase, the water, at the given temperature and pressure, soaks the coffee powder carrying out pre-cooking During pre-brewing, it is possible for coffee to be dispensed, if required by the type of beverage to be produced, but normally the pressures employed are not yet sufficiently high to break through the base of the structure of the capsule containing the coffee powder or the retaining strength of the coffee cake.

The extraction subphase comprises sending water at a temperature Tₑₛ and at a pressure Pₑₛ to the capsule, or to the containing means of the coffee powder. These values of Tₑₛ and of Pₑₛ are also variable as a function of the type of beverage to be produced. In particular, these values can assume a parameterized value constant in time or be dynamic variables with increasing or decreasing values.

The dispensing subphase comprises sending water at a temperature Tₑᵣ and at a pressure Pₑᵣ to the capsule, or to the containing means of the coffee powder. These values of Tₑᵣ and of Pₑᵣ are also variable as a function of the type of beverage to be produced. In particular, these values can assume a parameterized value constant in time or be dynamic variables, tendentially decreasing.

If all three subphases are necessary, at the end of this last one the level of dose of coffee required has been reached and, therefore, dispensing is interrupted, i.e. the operating cycle is terminated. The device could, moreover, perform further phases, not strictly correlated to the operating cycle, such as washing of the components or ejection of the coffee capsule or cake. With reference to FIG. 1, an embodiment of the movable device 1 for producing hot beverages, according to the present invention, is illustrated.

In particular, the term movable refers to a portable device, or a device that can be moved within the same room or positioned in different rooms.

The device 1 comprises heating means 40 for producing hot water and first sensor means 50 for measuring first temperature data of the hot water. It comprises further pumping means 200 of the water, operatively connected to the heating means 40, for producing pressurized water, second sensor means 30, for measuring the first pressure data of the pressurized water and dispensing means 100 of the beverages, operatively connected to the heating means 40 and to the pumping means 200. Moreover, the device 1 comprises control means 80, operatively connected to the first sensor means 50 and to the second sensor means 30, for continuous monitoring of the first temperature data and of the first pressure data during the operating phase of the dispensing means 100. The control means 80 are, moreover, operatively connected to the heating means 40 and to the pumping means 200 for continuous and combined control of the temperature and of the pressure during the operating phase of the dispensing means 100. In particular, the control means 80 comprise a first actuator 10 for controlling the heating means 40 and a second actuator 11 for controlling the pumping means 200.

The pumping means 200 are preferably constituted by a vibratory pump with frequency control. By way of example, frequency control allows a reduction in feed and flow rate, reducing the frequency, for the first subphase, increasing the flow rate in the second subphase and, finally, reducing the frequency, and therefore the flow rate, again in the last subphase. Alternatively, different types of pumping means 200 could be used, such as a gear pump or a volumetric pump or the like. In any case, the flow rate of the pump is varied, according to the present invention, as a function of the phases of the operating cycle and according to the type of beverage to be produced.

The dispensing means 100 comprise a dispensing unit 15, which comprises a brewing chamber 16, and a dispensing spout 18 for delivery of the beverage. The dispensing unit 15 is operatively connected to the heating means 40 by means of a solenoid valve 7. Moreover, this can also be connected to the dispensing spout 18 by means of a diverter solenoid valve 17. Furthermore, this same dispensing unit 15 comprises further devices adapted to produce the hydraulic seal in the subphases described previously, such as O-ring type sealing gaskets.

The first sensor means 50 comprise a temperature sensor at the heating means 40. This temperature sensor is, in this first embodiment, positioned on the heating means 40, or thermoblock, and is adapted to detect the temperature thereof. To improve the temperature detection sensitivity, the temperature sensor could be placed in contact, or almost, with the water coil of the heating means 40. The temperature sensor can, alternatively, be substituted by the safety thermostat.

The device 1 further comprises a tank 101, connected to the pump 2, to contain the water to be used during the operating phase.

Description of operation is made referring to the use of coffee in capsules. Nonetheless, the process described would be the same even if the coffee powder with different containers were to be used.

Moreover, reference is made to the production of only one type of beverage. This does not constitute a limitation as, according to the subsequent description, further embodiments can allow different beverages to be produced.

The user inserts the capsule into the brewing chamber 16 of the dispensing unit 15. The kinematic mechanism of this latter blocks the capsule in suitable position to allow subsequent extraction.

The beverage dispensing cycle is then started, controlled by means of the control means 80. During the operating phase, or the production cycle, at least two dynamic quantities, relating to temperature and pressure, are controlled continuously, in relation to the data provided by the first sensor means 50 and by the second sensor means 30. These are closely correlated to each other and decisive for the purpose of optimal extraction of a high quality beverage.

Further variables are, in this embodiment, predetermined, and therefore for the purposes of operation of the device 1 are used as parameters. These comprise the quality of the coffee blend contained in the specific capsule, roasting of the coffee blend, grain size of the particles, grammage, pressing of the ground product and quality of the water used for the beverage. Additional embodiments could comprise the possibility of controlling, at least partly, one or more of said parameterized variables.

The control means 80 receive from the temperature sensor 50 the temperature data relating to the water which will be used in the dispensing means 100. These are then compared with the values associated with the beverage to be produced. By means of a first actuator 10 the control means 80 control the supply of the heating means 40 of the thermoblock or boiler. In particular, the heating element, such as a resistor or the like, of the heating means 40 can be controlled according to different methods. In the embodiment described this is frequency controlled to obtain greater precision over control of the temperature to be reached. Alternatively, it can be controlled all the time at full power (in on/off mode) or current controlled. Control of the heating means 40 allows the desired temperature Tpi, Tes, Ter to be reached, according to the subphase to be performed, and interruption of heating when the water is ready to be used or at the end of the operating phase. In particular, frequency control allows, during the same subphase, the water temperature to be varied continuously with noteworthy precision.

The control means 80, by means of the second actuator 11, also control the pumping means 200. As described previously for the heating means 40, the pumping means 200 allow the desired pressure Ppi, Pes, Per to be reached, according to the subphase to be performed, and interruption of pressurization when the water is ready to be used or at the end of the operating phase. Also in this case, frequency control allows, during the same subphase, the water pressure to be varied continuously with noteworthy precision.

Dispensing of water inside the dispensing means 100, according to the temperatures and pressures required at each instant, takes place by means of the solenoid valve 7 which, when electrically energized by the control means 80, opens to allow the water to come into contact with the coffee powder. This solenoid valve 7 is, in fact, normally closed. The brewing chamber 16 brings the water into contact with the coffee powder producing the desired beverage. This is dispensed by means of the dispensing spout 18. The dose dispensed can be established simply by means of a volumetric dosing device 3 (not illustrated), which in the embodiment illustrated in FIG. 1 is positioned downstream of the pumping means 200. Otherwise, this volumetric dosing device 3 can be interposed between the tank 101 and the pumping means 200 or also positioned differently with the same effects.

Between the dispensing unit 15 and the dispensing spout 18 there is interposed a diverter solenoid valve 17. This latter provides for discharge of the water deriving from washing of the internal ducts without this water exiting from the dispenser spout and, therefore, being visible to the user. For example, this diverter solenoid valve 17, activated by the control element 80, could discharge the water into a collection basin inside the device. The diverter solenoid valve 17 also allows cleaning of any coffee residues to prevent cross contamination in the case of subsequent dispensing of different beverages.

Yet another advantage deriving from the diverter solenoid valve 17 is that of being able to empty the internal ducts without leaving water inside them. In fact, this water could cool down and alter the temperature at which the beverage is produced. Alternatively, this last operation described could be performed, with the same effects, by means of the solenoid valve 7, if this is of the “three-way” type.

FIG. 2 illustrates a second embodiment in which the device 2 also comprises beverage selection means. This embodiment is similar in all aspects to the previous one, with the difference that the device 2 is capable of producing different beverages in relation to the commands imparted to it.

The beverage selection means are operatively connected to the control means 80, sending to this latter data relating to second temperature data and second pressure data for the beverages selected for production. These second data are part of the “extraction profile” of the beverage, containing all the information necessary for correct implementation of the production activities.

By way of non-limiting examples, it is possible to identify three different profiles corresponding to espresso coffee, crème coffee and Americano coffee.

Espresso coffee is normally produced in a 25 cc of water with 7 g of coffee powder. The pre-brewing phase lasts 3 s with water at a pressure of 2 bar and temperature of 95° C. In the extraction phase the pressure reaches 20 bar and maintains this value for a given interval while the temperature drops to 93° C. The dispensing phase instead has decreasing temperature and pressure values, in particular the temperature is taken to 90° C. and the pressure to 10 bar.

Crème coffee has a pre-brewing phase of 2 s with a water temperature of 90° C. and a pressure of 2 bar. In the extraction phase the temperature is lowered to 89° C. while the pressure is increased to 15 bar. Finally, the dispensing phase leads to a decrease of both values, in particular the temperature is taken to 85° C. and the pressure to 10 bar.

American coffee has a very low pre-brewing time of 1 s with water temperature of 98° C. and pressure of 2 bar. The extraction phase, longer than the previous cases, has a temperature value of 99° C. and pressure value of 2 bar. The dispensing phase, equivalent to 4 s, instead has a temperature value of 95° C. and a pressure value of 2 bar.

According to FIG. 2, the selection means comprise, in this second embodiment of the device 2, first storage means 13 of the extraction profiles, operatively connected to the control means 80, and also comprise selection actuator means 19. The first storage means 13 are produced by means of a non-volatile memory capable of associating with each profile entered a different combination of parameters for extraction of the correct beverage. In fact, the device 2 can already contain in the memory the different extraction profiles, such as espresso coffee American coffee, tea and others. These can be associated with the selection actuator means 19, such as a push button panel or a touch screen system or the like, to allow the user to select the desired extraction profile. Moreover, the different extraction profiles can be modified in the machine through access to programming mode, for example through a PIN code, in the first storage means 13.

Furthermore, but not necessarily, these selection means comprise second storage means 14 of the extraction profiles, operatively connected to the first storage means 13 and to the control means 80. In this second embodiment, these second storage means 14 consist of a non-volatile memory external to the device 2 and capable of operatively connecting to the first storage means 13 or directly to the control means 80. In particular, these second storage means 14 consist of a portable non-volatile memory, such as a memory card (SD, MMC or the like), a Smart Card (or chip card), a Bluetooth device, a USB key or the like.

Furthermore, these storage means 14 could use an extraction profile taken from a web page, for example through the use of a mobile telephone device operatively connected to the device 1. Moreover, the profile could be loaded on devices utilizable as prepaid credit. Finally, these second storage means 14 could control the machine remotely, for example by mean of Wi-Fi, if the machine is connected to a network, remotely communicating the extraction profile to be used and acquiring or supplying further data related to dispensing. The extraction profiles are stored in advance in said second storage means 14. Moreover, these profiles can be updated and modified directly by the user by means of the device 2, as described previously, or by an external body which prevents further processing operations. Furthermore, the second storage means 14 could act as electronic key allowing the device 2 to be enabled to dispense the beverage only when this is entered or in connection therewith, or when it has prepaid credit to enable dispensing.

The device 2 operates in the same manner as the previous device, taking account of appropriate variants due to the possibility of selecting the beverage to be produced. In particular, by means of the actuator means 19 the user selects a beverage to be produced. The choice of the beverage allows the beverage selection means to send to the control means 80 the data relating to second temperature data and second pressure data, part of the so-call extraction profile, for the beverages selected.

Therefore, the control means 80 perform continuous and combined control of the temperature and of the pressure during the operating phase on the basis of comparison between said first temperature data detected and the second temperature data of the profile and, moreover between the first pressure data detected and the second pressure data of the profile. The subsequent operations are the same as those described previously.

FIG. 3 illustrates a third embodiment in which the first sensor means 50, 60 comprise a temperature sensor at the dispensing means 100 and a temperature sensor at the heating means 40. The device has the same configuration described for the previous device, in which, moreover, the first sensors 50, 60 comprise a first temperature sensor 50 positioned on the heating means 40, and a second temperature sensor 60, positioned downstream of the hot water dispensing point of the same heating means 40.

In this way, there are two temperature control points, which make detection of said data more precise. In order for management of the temperature to be as efficient as possible, the second sensor 60 could be positioned immediately in series with the heating means 40.

For the same purpose, also the solenoid valve 7 could be positioned immediately in series, thereby allowing any cold water remaining in the ducts to be discharged by this to the dispensing point. Moreover, the order between the second sensor 6 and the solenoid valve 7 could be inverted without any relevant effect. Operation of the device 3 is the same as described for the previous devices 1 and 2, except for combined management of the temperature detections, if different, by the control means 80.

FIG. 4 illustrates a fourth embodiment in which the device 4 also comprises third sensor means 5′ for measuring third temperature data of the input water to the heating means 40. The advantage of a further temperature sensor that detects the temperature of the input water lies in greater precision of the operating phase. In fact, in this way the variations in temperature of the input water can be kept under control, whatever the supply source. By means of this embodiment, also controlling parameters such as the pressure and the volume of the water effectively dispensed through the pumping means 200, constituted by a volumetric dosing device, it is possible to calculate the thermal gradient necessary to obtain the desired temperature of the water dispensed by the heating means 40. Therefore, by means of the control means 80, the number of calories to be produced and the energy required for this purpose are calculated. In this case, the second temperature sensor 60 performs a control for the feedback which can subsequently trigger corrective actions to improve the efficiency of the device 4.

According to this embodiment, the variable of the temperature value of the input water becomes irrelevant. Any thermal gradients, relating to the room in which the device 4 or the tank 101 are positioned become unimportant, as do the differences in temperature of the mains water supply due, for example, to changes of season, when the device 4 is connected directly thereto.

In an alternative embodiment, not illustrated, the dispensing means 100 comprise a brewing chamber 16 with variable geometry. The control means 80 are operatively connected to the infusion chamber 16 for continuous and combined control of the temperature and of the pressure on the basis of the geometry of the same brewing chamber 16.

Alternatively, or additionally, the brewing chamber 16 can have a variable volume. The control means 80, operatively connected to the brewing chamber 16 will, therefore, perform continuous and combined control of the temperature and of the pressure also on the basis of the volume of the brewing chamber 16.

The possibility of variation of the geometry and/or of the volume of the brewing chamber 16 allows the use of different types of containing means for the coffee powder, such as capsules.

In fact, the control means 80 automatically adapt the temperature and/or pressure in the brewing chamber 16 in relation to the geometry and/or to the volume assumed by this latter. FIG. 5 illustrates a sixth embodiment of the device 5, also comprising timer means for monitoring the heating time interval, the pressurization time interval and the dispensing time interval. The control means 80 are operatively connected to the timer means for control of the time intervals.

Moreover, in this embodiment, the device 5 comprises mixing means 21 for mixing the hot water produced by the heating means 40 with the input cold water to these latter. Furthermore, the mixing means 21 can comprise at least one temperature sensor, operatively connected to the control means 80.

By means of this embodiment, an efficient control system is achieved on the operation, and moreover, a safety system is introduced. Assuming that the device 6 comprises heating means 40 that operate completely full, i.e. always with water inside them, when dispensing is performed, the control means 80 must check that the water temperature is at the desired value. If it has a value already exceeding the temperature required, for example because the previous dispensing operation required a higher temperature, the control means 80 must perform one of the following operations. They can inhibit dispensing for the necessary time, using the timer means described, discharge all the excess hot water through the third outlet of the solenoid valve 7 as described previously, or alternatively activate the mixing means 21 to mix hot water and cold water. In this case, the temperature sensor provided on the mixing means would provide the control means 80 with the necessary data relating to the temperature values reached during mixing.

FIG. 6 illustrates a further variant of said embodiment of the device 6 in which there is inserted a proportional valve 20 to control dispensing of cold water. The same result can be obtained by inserting a Y joint downstream of the pumping means 200. In this case, one branch would supply the heating means 4 with cold water to be heated. The other branch would be connected to the hot water dispensing point of the heating means 40 and upstream of the second temperature sensor 60 and of the solenoid valve 7. The Y joint element is, therefore, adapted to mix the cold water, the flow rate of which can be predetermined by a throttle or by the proportional valve 20.

A further embodiment of the device 7, illustrated in FIG. 7, comprises a proportional valve 20′ positioned downstream of the pumping means 200 and upstream of the heating means 4. By means of this value, it is possible to vary the pressure by varying the through section. In this way, as it is operatively connected to the control means 80, the pressure would be controlled directly by acting on the proportional valve 20′ by means of the control means 80 and the pumping means 200 would influence only the flow rate of the water.

A variant of the embodiments described, illustrated in FIG. 8 by means of the device 8, comprises a different water supply source. In particular, instead of the tank 101, the device comprises a direct connection to the mains water network 23, operatively connected to the pumping means 200. Between these two there can be interposed a device 22 adapted to reduce the network pressure to a constant value before introducing the water into the pumping means 200.

The embodiments described and illustrated are only examples to effectively describe the technical elements of the device according to the invention. All the technical elements described in each embodiment can also be combined with one another to implement new embodiments, not described.

The device for producing beverages according to the present invention is therefore very flexible and allows the production of different types of beverage by means of a single device. It also ensures rapid operations and set-up modifications between two different subsequent beverages.

The possibility of directly and constantly controlling at least two variables, such as temperature and pressure, allows the production of a large number of high quality beverages. Moreover, this constant, combined and independent control allows beverages to be produced according to more suitable or more pleasing extraction profiles.

The device for producing beverages according to the invention performs effective control of the operating phases. In fact, it allows prompt control of at least the temperature and pressure variables in each subphase of the operating phase.

A device produced according to the present invention also allows rationalization of the elements of which it is formed, and of the production costs associated thereto in relation to the minimum number of parts used and to the operations necessary for their assembly. The numerous possible embodiments also allow the device to be highly personalized according to the characteristics desired and the rooms in which it is used.

The description, provided with reference to the production of a hot coffee beverage, can also be extended to the production of other types of hot beverages such as, by way of non-limiting example, tea.

1. Device for producing hot beverages, characterized in that it comprises:
a. heating means for producing hot water
b. first sensor means for measuring first temperature data of said hot water
c. pumping means of said hot water, operatively connected to said heating means, for producing pressurized hot water
d. second sensor means for measuring first pressure data of said pressurized hot water
e. dispensing means of said beverages, comprise at least one brewing chamber with variable geometry, operatively connected to said heating means and to said pumping means;
said device also comprising control means, operatively connected to said first sensor means and to said second sensor means, for continuous monitoring of said first temperature data and of said first pressure data during the operating phase of said device; said control means being operatively connected to said heating means and to said pumping means for continuous and combined control of said temperature and of said pressure during said operating phase of said device; said control means being operatively connected to said brewing chamber for continuous, combined and independent control of said temperature and of said pressure on the basis of the geometry of said brewing chamber; said geometry being determined on the basis of the extraction profile of said beverages.

2. Device according to claim 1, characterized in that it comprises beverage selection means, operatively connected to said control means; said selection means sending at least second temperature data and/or second pressure data for said beverages to said control means; said control means performing continuous and combined control of said temperature and of said pressure during said operating phase on the basis of comparison between said first temperature data and said second temperature data and/or between said first pressure data and said second pressure data.

3. Device according to claim 2, characterized in that said selection means can be controlled by a user.

4. Device according to claim 1, characterized in that said first sensor means comprise at least a temperature sensor at said dispensing means and/or at least a temperature sensor at said heating means.

5. Device according to claim 1, characterized in that it comprises third sensor means for measuring third temperature data of the input water to said heating means.

6. Device according to claim 1, characterized in that said brewing chamber has a variable volume; said control means (80) being operatively connected to said brewing chamber for continuous, combined and independent control of said temperature and of said pressure on the basis of the volume of said brewing chamber; said volume being determined on the basis of the extraction profile of said beverages.

7. Device according to claim 1, characterized in that it comprises timer means for monitoring the heating time interval and the pressurization time interval; said control means being operatively connected to said timer means to control said heating time interval and said pressurization time interval.

8. Device according to claim 1, characterized in that said timer means monitor the dispensing time interval; said control means being operatively connected to said timer means to control said dispensing time interval.

9. Device according to claim 1, characterized in that it comprises mixing means for mixing said hot water produced by said heating means with the input cold water to said heating means.

10. Device according to claim 9, characterized in that said mixing means comprise at least one temperature sensor, operatively connected to said control means.

11. Device according to claim 2, characterized in that said first sensor means comprise at least a temperature sensor at said dispensing means and/or at least a temperature sensor at said heating means.

12. Device according to claim 3, characterized in that said first sensor means comprise at least a temperature sensor at said dispensing means and/or at least a temperature sensor at said heating means.

13. Device according to claim 2, characterized in that it comprises third sensor means for measuring third temperature data of the input water to said heating means.

14. Device according to claim 3, characterized in that it comprises third sensor means for measuring third temperature data of the input water to said heating means.

15. Device according to claim 4, characterized in that it comprises third sensor means for measuring third temperature data of the input water to said heating means.

16. Device according to claim 2, characterized in that said brewing chamber has a variable volume; said control means being operatively connected to said brewing chamber for continuous, combined and independent control of said temperature and of said pressure on the basis of the volume of said brewing chamber; said volume being determined on the basis of the extraction profile of said beverages.

17. Device according to claim 3, characterized in that said brewing chamber has a variable volume; said control means being operatively connected to said brewing chamber for continuous, combined and independent control of said temperature and of said pressure on the basis of the volume of said brewing chamber; said volume being determined on the basis of the extraction profile of said beverages.

18. Device according to claim 4, characterized in that said brewing chamber has a variable volume; said control means being operatively connected to said brewing chamber for continuous, combined and independent control of said temperature and of said pressure on the basis of the volume of said brewing chamber; said volume being determined on the basis of the extraction profile of said beverages.

19. Device according to claim 5, characterized in that said brewing chamber has a variable volume; said control means being operatively connected to said brewing chamber for continuous, combined and independent control of said temperature and of said pressure on the basis of the volume of said brewing chamber; said volume being determined on the basis of the extraction profile of said beverages.

20. Device according to claim 2, characterized in that it comprises timer means for monitoring the heating time interval and the pressurization time interval; said control means being operatively connected to said timer means to control said heating time interval and said pressurization time interval.
